(19) United States
(12) Patent Application Publication
(10) Pub. No.: US 2012/0330805 A1
(43) Pub. Date: Dec. 27, 2012

(54) Electronic Invoice and Payment System with Graphic Invoice Approval and Payment Status Reporting.

(75) Inventors: Robert Arntz Eberle, North Hampton, NH (US); Amy Beth Hoke, Gilford, NH (US)

(73) Assignee: Bottomline Technologies (DE) Inc., Portsmouth, NH (US)

(21) Appl. No.: 13/603,856

(22) Filed: Sep. 5, 2012

Related U.S. Application Data
(63) Continuation-in-part of application No. 13/068,558, filed on May 13, 2011.
Application No. 13/068,558 is a continuation-in-part of application No. 13/136,728, filed on Aug. 9, 2011.
Application No. 13/136,728 is a continuation-in-part of application No. 13/200,581, filed on Sep. 26, 2011.

(51) Int. Cl. G06Q 30/04; G06Q 20/14

(52) U.S. Cl. 705/34

(57) ABSTRACT

A system includes an invoice application which, in response to a report request comprising access credentials of a connecting vendor, obtains a list of the vendor's open invoices from a database and generates a report document. The report document comprises a group of horizontal rows, each row representing a unique one of the vendor's invoices. Each row comprises an invoice identifier and a multi-segment status control. The status control comprises a group of segments within the horizontal row, with each segment representing a unique one of the steps the buyer performs to approve and pay the invoice. Each segment is a first color if the segment represents a processing step that the buyer has not yet performed and a second color if the segment represents a processing step that the buyer has completed.

### TECHNICAL FIELD

The present invention relates to electronic delivery of invoices and more particularly, to a system for delivering invoices and providing a vendor with enhanced reporting capabilities which include a graphic indication of invoice approval and payment status.

### BACKGROUND OF THE INVENTION

Traditional invoice presentment and payment solutions between vendors and their buyers include paper-based invoice presentment and payment. In this scenario, the steps required to send an invoice (on the vendor's side) receive and approve the invoice, and pay the invoice (on the buyer's side) relies on a series of paper-based procedures. For example, typical paper-based invoice presentment and payment relies on first distributing invoices via mail. In some large organizations, it is desirable (and usually required) to include separation of duties between invoice approval and actual payment, for audit purposes. Accordingly, invoices, once received, may go through several approval steps before payment is made. Upon receipt by an organization, the invoice must be approved by an applicable individual who determines such matters such as whether the invoice is accurate with respect to price, goods received, and/or discount terms. The invoice is then forwarded to the next individual in the accounts payable chain, until ultimately the invoice is authorized for payment.

Another individual is typically responsible for creating and distributing a check to the biller, again by mail procedures. From distribution of the invoice by the vendor to cash being posted by the vendor's accounts receivable (A/R) system, the typical time is two weeks or more.

During this period of time vendors are disadvantageously unaware of the status of the invoice in the buyer's accounts payable system and may not even be aware of any problems with the invoice which could be delaying payment. Moreover, any adjustments to the invoice made by the buyer are not reflected in the vendor's A/R and will be problematic reconciling a check not matching the invoice amount upon receipt by the vendor.

Therefore, there exists a need to provide an electronic invoicing and payment system which serves the needs of business relationships by providing on-line invoice presentment which includes means for reporting invoice approval and payment status to the vendor in a graphic format.

### SUMMARY OF THE INVENTION

A first aspect of the present invention comprises a payment status reporting system. The payment status reporting system comprises a database encoded to computer readable medium and including a group of invoice objects. Each invoice object comprises: i) an invoice identifier; ii) identification of a buyer; iii) identification of a vendor; iv) invoice data; and v) a status flag identifying a completed step within a group of at least three processing steps the buyer performs to approve and pay the invoice.

An invoice application comprising instructions stored in a computer readable memory and executed by a processor. The instructions comprise, in response to a vendor query, generating a report document. The report document comprises a group of horizontal rows with each row representing a unique one of the group of invoice objects from the database.

Each row includes the invoice identifier and a multi-segment status control. The multi-segment status control comprising a group of segments within the horizontal row. Each segment represents a unique one of the steps of the group of at least three processing steps the buyer performs to approve and pay the invoice. Each segment being a first color, such as blue, if the segment represents a processing step that the buyer has not yet performed for the invoice identified in the row. Each segment is a second color, distinct from the first color, such as green, if the segment represents a processing step that the buyer has completed for the invoice identified in the row.

The system may further include an exception object. The exception object comprises, for each of the group of at least three processing steps the buyer performs to approve and pay the invoice, identification of at least one criteria for determining whether an exception condition exists for that processing step.

The instructions of the invoice application further comprise, for each step of the at least three processing steps, using the criteria to determining whether an exception condition exists. The step of generating the report may further comprise populating the segment of the multi-segment status control with a third color, such as red, distinct from the first color and the second color if the exception condition exists.

In this embodiment, the except object further comprises a pop-up window template and the step of populating the segment of the multi-segment status control with the third color further comprises populating the segment with a link. Upon user selection of the link, rendering a pop-up object on a display which identifies the exception condition.

In another sub-embodiment, the database may further comprise, in association with each invoice object, a text field which, if populated with text by the buyer is an exception condition for at least one step of the group of at least three processing steps the buyer performs to approve and pay the invoice. In this sub-embodiment the step of rendering an object on the display which identifies the exception condition includes, if the exception condition is text populated by the buyer to the text field, a rendering of the text populated to the text field in the pop-up object.

In another embodiment, the group of three processing steps further comprises at least a fourth processing step. The fourth processing step may be a step which: i) the buyer performs to approve and pay the invoice if the invoices is a first type of invoice; and ii) the buyer does not perform if the invoice is a second type of invoice distinct from the first type of invoice.

In this embodiment, the steps of the invoice application further identify whether the invoice is the first type of invoice or the second type of invoice and, if the invoice is the first type, the multi-segment status control comprises a fourth segment representing the fourth step, the fourth segment being the first color if the fourth processing step has not yet been performed for the invoice identified in the row and the second color if the fourth processing step. If the invoice is the second type, the multi-segment status control excludes the fourth segment.

A second aspect of the present invention comprises a method of reporting approval and payment status of a group of invoices issued by a vendor. The method comprises, in response to a report request comprising access credentials of a connecting vendor, obtaining from a database, for each invoice having at least an invoice having an identification of an issuing vendor matching the connecting vendor, an invoice ID number and, with respect to at least three processing steps a buyer performs to approve and pay the invoice, identification of whether the buyer has performed the processing step.

The method then comprises rendering a report document on a display screen. The report document comprises a group of horizontal rows with each row representing a unique one of the group of invoice objects obtained from the database.

Each row includes the invoice identifier and a multi-segment status control comprising a group of segments arranged linearly within the horizontal row. Each segment represents a unique step within the group of at least three processing steps the buyer performs to approve and pay the invoice.

Each segment is populated a first color if the segment represents a processing step that the buyer has not yet performed for the invoice identified in the row and a second color, distinct from the first color, if the segment represents a processing step that the buyer has completed for the invoice identified in the row.

In one sub embodiment, with respect to each processing step that the buyer has not yet performed for the invoice identified in the row, the method further includes looking up exception criteria and determining whether an exception condition exists for that processing step.

If an exception condition exists for the processing step, rendering the segment which corresponds to the processing step a third color distinct from the first color and the second color.

Further, if an exception condition exists for a processing step, the segment which corresponds to the processing step may be rendered as an active link. Upon user selection of the active link, the method may include rendering a pop-up object over the report document. The pop-up object identifies the exception condition.

If the exception condition includes any buyer entered text, the step of rendering a pop-up object over the report document includes, rendering of the text populated by the buyer within the pop-up window.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of an invoice presentment and payment system in accordance with an exemplary embodiment of the present invention;

FIG. 2 is a diagram representing a buyer system in accordance with an exemplary embodiment of the present invention;

FIG. 3 is a diagram representing a vendor system in accordance with an exemplary embodiment of the present invention;

FIG. 4a is a diagram representing a vendor registry in accordance with an exemplary embodiment of the present invention;

FIG. 4b is a diagram representing a buyer registry in accordance with an exemplary embodiment of the present invention;

FIG. 4c is a diagram representing an invoice database in accordance with an exemplary embodiment of the present invention;

FIG. 4d is a diagram representing an invoice object in accordance with an exemplary embodiment of the present invention;

FIG. 5 is a diagram of a graphic invoices status report template populated as a graphical invoice status report on a tablet computer in accordance with an exemplary embodiment of the present invention;

FIG. 6 is a flow chart representing operation of an aspect of an invoice application in accordance with an exemplary embodiment of the present invention;

FIG. 7a is a diagram of a graphic invoices status report template populated as a graphical invoice status report on a tablet computer, rendering a pop-up window for a disputed invoice in accordance with an exemplary embodiment of the present invention;

FIG. 7b is a diagram of a graphic invoices status report template populated as a graphical invoice status report on a tablet computer, rendering a pop-up window for a an invoice with an exception condition in accordance with an exemplary embodiment of the present invention;

FIG. 8a is a diagram representing an exception object in accordance with an exemplary embodiment of the present invention;

FIG. 8b is a diagram representing dispute codes in accordance with an exemplary embodiment of the present invention;

FIG. 9a is a table diagram representing data elements stored in, and relationships between data elements stored in, a payment instruction file in accordance with a first exemplary embodiment of the present invention;

FIG. 9b is a table diagram representing data elements stored in, and relationships between data elements stored in, a payment instruction file in accordance with a second exemplary embodiment of the present invention;

FIG. 9c is a table diagram representing data elements stored in, and relationships between data elements stored in, a payment instruction file in accordance with a third exemplary embodiment of the present invention;

FIG. 10a is a ladder diagram representing a combination of data structures and instructions stored in memory and executed by a processor for making payments from each payer of a community of payers to each vendor of a community of vendors, all in accordance with an exemplary embodiment of the present invention;

FIG. 10b is a ladder diagram representing a combination of data structures and instructions stored in memory and executed by a processor for making payments from each payer of a community of payers to each vendor of a community of vendors, all in accordance with an exemplary embodiment of the present invention;

FIG. 11 is a graphic depicting an exemplary user interface for funding amount approval in accordance with and exemplary embodiment of the present invention;

FIG. 12 is a flow chart representing instructions stored in memory and executed by a processor for calculating a variable transaction fee in accordance with an exemplary aspect of the present invention;

FIG. 13 is a table diagram representing data elements stored in, and relationships between data elements stored in, an electronic funds transfer file in accordance with an exemplary embodiment of the present invention;

FIG. 14 is a flow chart representing instructions stored in memory and executed by a processor for populating records of an operator fee transaction in accordance with an exemplary aspect of the present invention; and

FIG. 15 is a flow chart representing instructions stored in memory and executed by a processor for populating records of revenue share transaction in accordance with an exemplary aspect of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is intended to encompass a hardware circuit (whether discrete elements or an integrated circuit block), a processor or control block executing code encoded in a computer readable media, or a combination of a hardware circuit(s) and a processor and/or control block executing such code.

It should also be appreciated that table structures represented in this application are exemplary data structures only, of a non transitory nature embodied in computer readable memory, and intended to show the mapping of relationships between various data elements. Other table structures may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

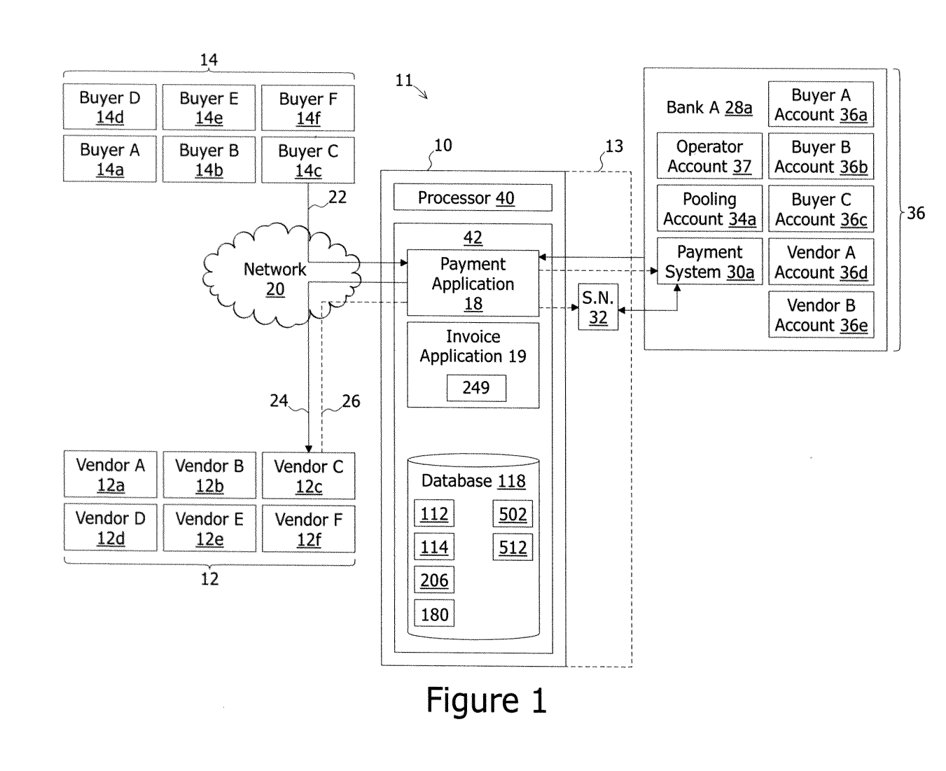

Turning to FIG. 1, an exemplary architecture 11 is shown in which an invoice presentment and payment system 10: i) delivers invoices from each vendor 12a-12f of a community of vendors 12 to each buyer 14a-14f of a community of buyers 14; and ii) executes payments from each buyer 14a-14f of a community of buyers 14 to each vendor 12a-12f of a community of vendors 12.

For purposes of compensating the operator of the system 10, it may assess a network fee to each vendor in conjunction with executing a payment from a buyer to the vendor. The network fee assessed to the vendor is based on a variable transaction rate. More specifically, the fee is the product of multiplying the amount of the payment by the rate that is applicable to payments made by the particular buyer to the particular vendor. The rate is referred to as “variable” because: i) the rate is variable amongst vendors, the same buyer may use different rates for different vendors; and ii) the rate is variable amongst buyers, the same vendor may be subjected to different rates, based on the particular buyer making the payment.

The network fee may be paid to the operator of the system 10 as an operator fee. Further, a portion of the network fees assessed on payments made by each buyer may be paid, as variable revenue share, or variable rebate payment to the buyer.

The system 10 is communicatively coupled to each buyer 14a-14f of the community of buyers 14 and to each vendor 12a-12f of the community of vendors 12 via an open network 20 such as the public internet.

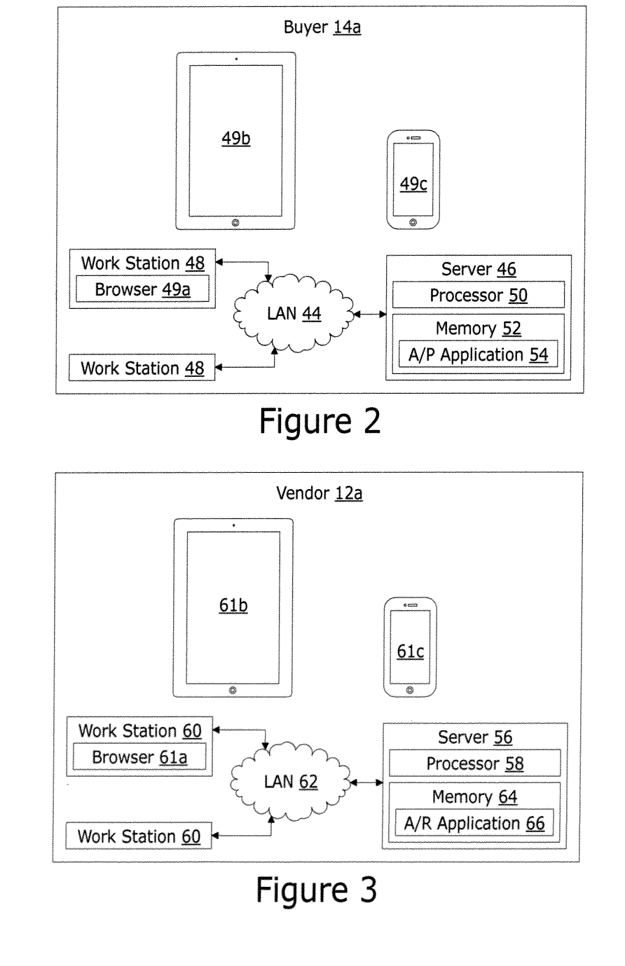

Turning briefly to FIG. 2 in conjunction with FIG. 1, in an exemplary embodiment, each buyer, using buyer 14a for example, may be a business that includes at least one computer system or server 46. The computer system(s) or server(s) 46 include at least one processor 50 and associated computer readable medium 52 programmed with an accounts payable application 54.

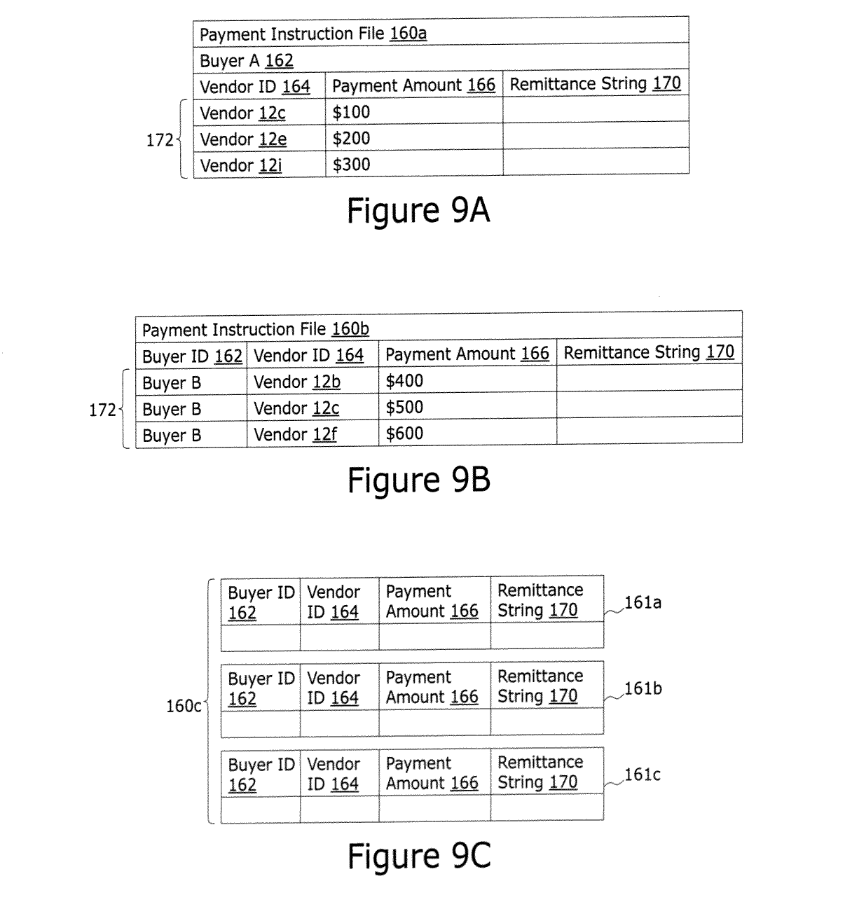

In a typical environment, the computer system(s) or server(s) 46 operating the accounts payable application 54 may be coupled to a local area network 44 and accessed by entitled users of workstations 48 and may be used for managing the buyer's accounts payables and issuing payments to its vendors. The accounts payable application 54 may issue the payment instructions and/or payment instruction files described with respect to FIGS. 9a, 9b, and 9c.

Each buyer, again using buyer 14a as an example, may further include one or more access systems for interfacing with the system 10. Exemplary access systems include: i) a web browser 49a on a workstation 48 or other computer which accesses system 10 via a web connection; ii) a tablet computer 49b such as an iPad which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

Turning briefly to FIG. 3 in conjunction with FIG. 1, in an exemplary embodiment, each vendor, using vendor 12a for example, may be a business that includes at least one computer system or server 56. The computer system(s) or server(s) 56 include at least one processor 58 and associated computer readable medium 64 programmed with an accounts receivable application 66.

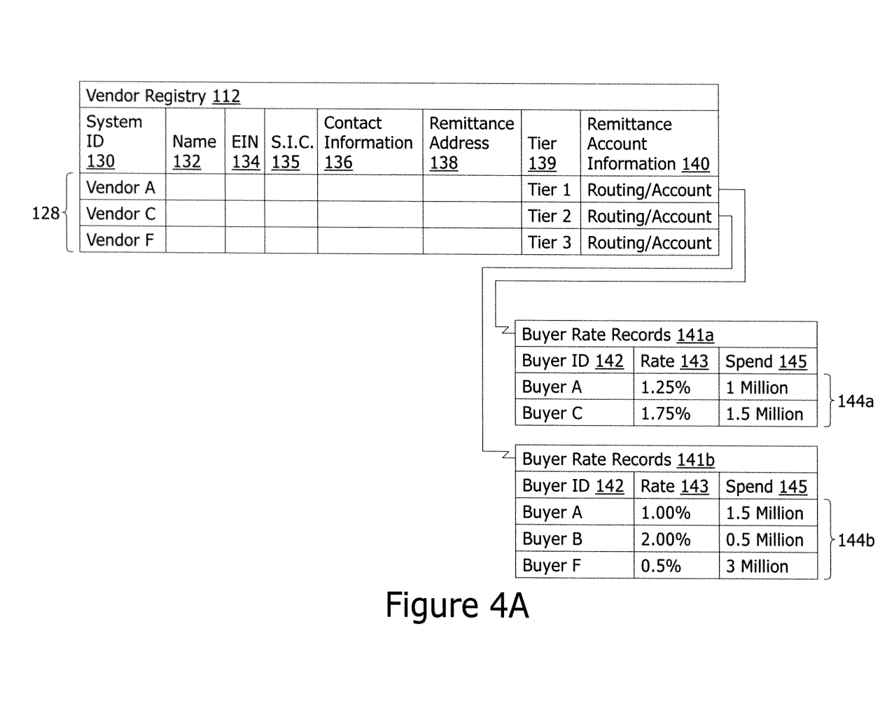

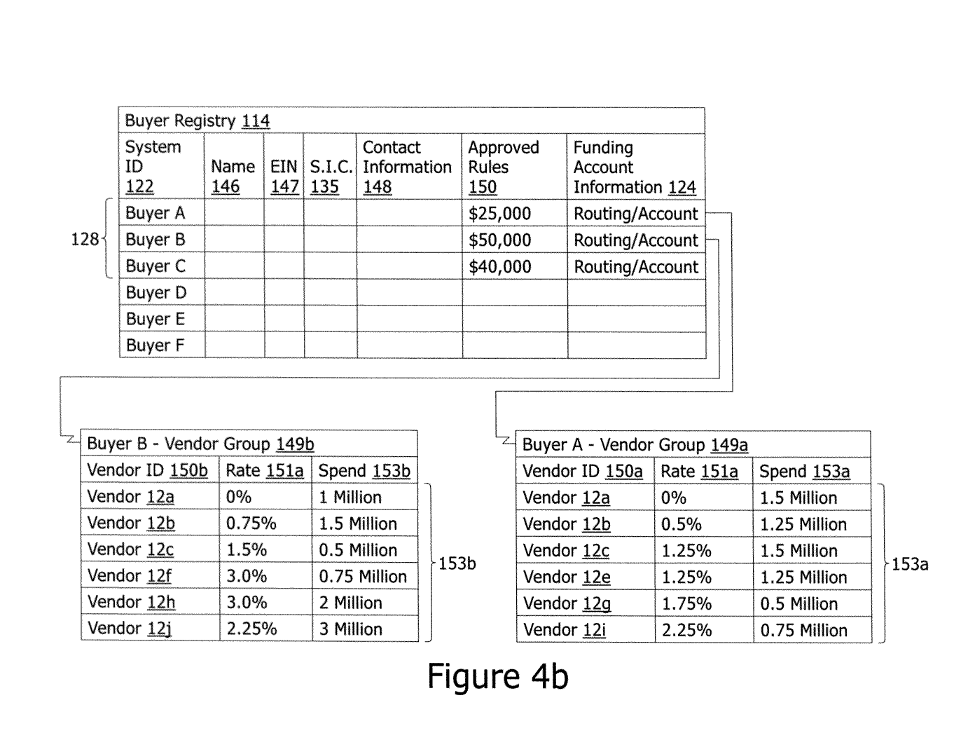

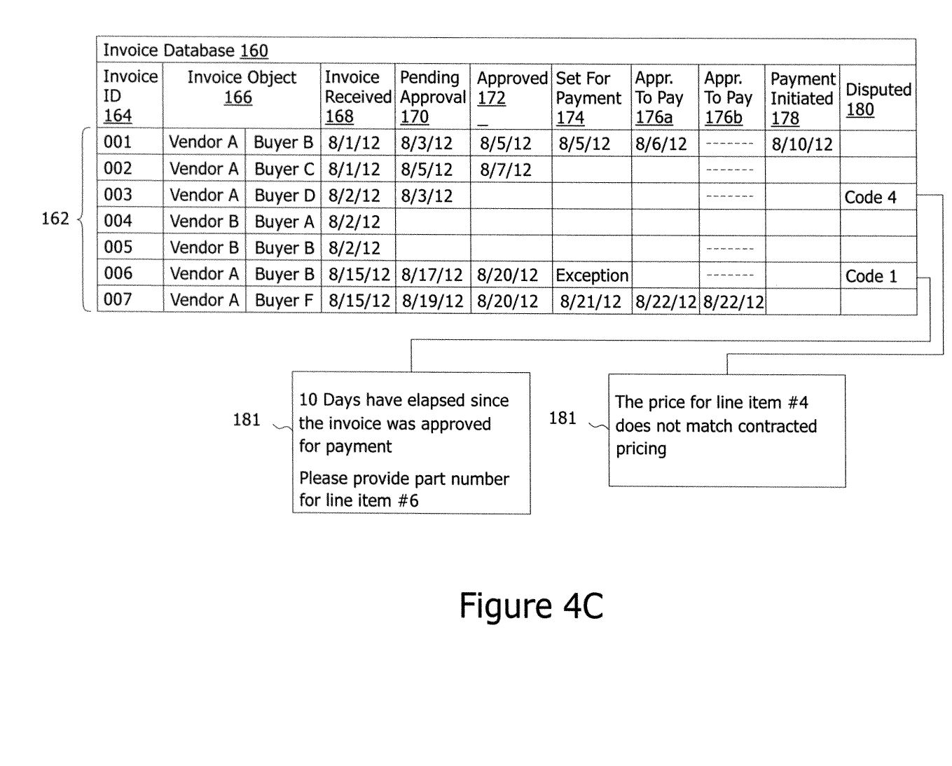

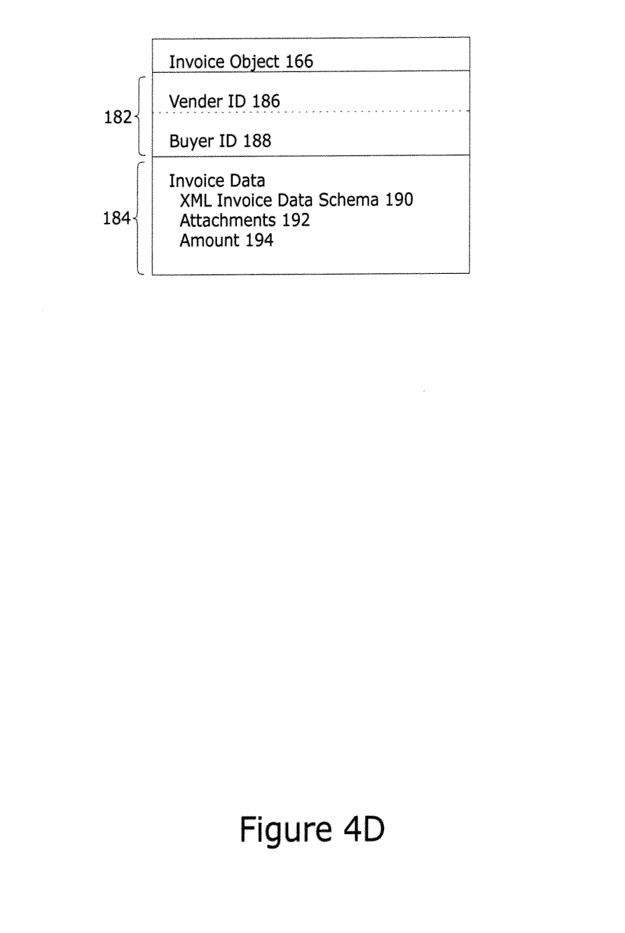

In a typical environment, the computer system(s) or server(s) 56 operating the accounts receivable application 66 may be coupled to a local area network 62 and accessed by entitled users of workstations 60 and may be used for issuing invoices and managing the vendor's accounts receivables and reconciling payments issued by customers (i.e. buyers) against amounts due to the vendor. The NR application 66 may issue the invoices described with respect to FIGS. 4c and 4d.

Each vendor, again using vendor 12a as an example, may further include one or more access systems for interfacing with the system 10. Again, exemplary access systems include: i) a web browser 61a on a workstation 60 or other computer which accesses system 10 via a web connection; ii) a tablet computer 61b such as an iPad which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, a participating bank 28 is depicted. The bank 28 may include a payment system 30 (i.e. instructions coded to a computer readable medium and executed by a processor) which may manage customer deposit accounts 36a-36e for a portion of the buyers 14a-14f and/or a portion of the vendors 12a-12f, including execution of credit and debit transactions to deposit accounts 36a-26e in a traditional manner.

For example, the bank 28 may have a customer account 36a for Buyer 14a, a customer account 36b for buyer 14b, a customer account 36c for buyer 14c, a customer account 36d for vendor 12a, a customer account 36e for vendor 12b.

Each customer account for a buyer may be a deposit account such as a commercial checking account. Each customer account for a vendor may be a deposit account such as a commercial checking account or a merchant services account such as an account funded upon settlement of a card payment transaction.

The payment system 30 may further be coupled to a settlement network 32 which transfers funds between banks for settlement of payments between accounts a different banks. Exemplary settlement networks include the National Automated Clearing House Association (NACHA) for settling ACH transactions and the Federal Reserve for settling wire transactions. The settlement network may also be a card payment system operator such as American Express or a bank card brand provider—or an association, such as bank card brand providers Visa or MasterCard, which settles payments typically referred to as card payments.

The bank 28 may further include, and the banks' payment system 30 may further manage, a settlement or pooling account 34 which may be a fiduciary consolidation account with legal title to funds therein belonging to the bank, such as a commercial checking account, to which credits and debit transactions are posted representing credits to fund payments to be issued by buyers and debits to disburse payment to vendors.

The bank 28 may further include, and the bank's payment system 30 may further manage, an operator account 37 which may be a deposit account to which credits and debit transactions are posted representing credits and debits to funds of the operator of the system 10.

In an exemplary embodiment, the invoice presentment and payment system 10 may be communicatively coupled to the bank's payment system 30. In another exemplary embodiment, the invoice presentment and payment system 10 may further be coupled to the settlement network 32, or may alternatively be coupled to the settlement network 32 in lieu of being coupled to a the bank's payment systems 30.

In yet another exemplary embodiment, the settlement network 32 may be part of the invoice presentment and payment system 10 as depicted by the dashed line 13 in FIG. 1. For example, if the invoice presentment and payment system 10 is operated by a bank card association the invoice presentment and payment system 10 may include a proprietary settlement network 32.

The invoice presentment and payment system 10 may be a computer system of one or more servers comprising at least a processor 40 and computer readable medium 42. The computer readable medium may include encoded thereon an invoicing application 19, a payment application 18, and database 118. Each of the invoicing application 19 and payment application 18 may be a computer program comprising instructions embodied on computer readable medium 42 and executed by the processor 40. The database 118 may include data structures, also referred to as tables, as described herein and may include instructions embodied on computer readable medium 42 for interfacing with the invoicing application 18 and payment application 18 for reading and writing data to the data structures and tables.

Turning briefly to FIG. 4a in conjunction with FIG. 1, the database 118 may further include, as one of the data structures, a vendor registry 112. The vendor registry 112 may comprise a group of vendor records 128. The group of vendor records 128 may comprise unique records, each of which is associated with, and identifies, a unique one of the vendors of the community of vendors 12 by inclusion of a unique system ID (for example, Vendor A, Vendor B, and Vendor C) within a system ID field 130 of the record.

Also associated with the vendor may be: i) the vendors name included in a name field 132; ii) the vendor's tax identification number included in a tax ID field 134; iii) the vendor's industry code 135; iv) the vendor's contact information included in a contact information field 136; v) the vendors remittance address included in a remittance address field 138; vi) the vendor's service tier included in a service tier field 139, and v) the vendors remittance account identifier included in a remittance account identifier field 140.

The vendor's name 132 may be the official name of the entity as recorded in official records of the jurisdiction in which it is formed and as used for titling its bank accounts, including its remittance account.

The vendor's industry code 135 may be the code of the group of industry codes 207 which represents the industry or commercial activity in which the vendor participates.

The vendor's contact information 136 may include the name of an individual in the vendor's accounts receivable department responsible for managing the vendor's accounts receivable matters with the buyers 22.

The vendor's remittance address 138 may be an address the vendor typically uses for receiving checks from its customers by regular mail (for example a lock box address).

The vendor's service tier 139 may represent one of three or more service tiers to which the vendor is assigned based on aggregate network fees paid by the vendor. The invoice presentment and payment system 10 to provide more services to vendors that pay higher aggregate network fees.

The vendor's remittance account identifier 140 may identify the bank at which the vendor's remittance account is held, such as by an ABA routing number, an account number, and/or other information needed by the payment system 30 and/or settlement network 32 to execute deposits to the vendor's account in accordance with payment authorization instructions provided by a buyer.

Each record 128 of the vendor registry 112 may further associate with a unique group of buyer rate records 141a, 141b. The unique group of rate records 141 associated with a record 128 of the vendor registry identifies, for that vendor identified in the record 128, those buyers which make payment to the vendor and the buyer specific transaction rate to apply to payments from the buyer to the vendor. For example the record 128 associated with Vendor A may associate with buyer rate records 141a. The buyer rate records 141a include: i) a record with Buyer A populated to the Buyer ID field 142, 1.25% populated to the rate field 143 indicating that a network fee rate of 1.25% applies to payments made by Buyer A to Vendor A, and $1 Million populated to a spend field 145 indicating that aggregate payments from Buyer A to Vendor A over a predetermined period of time (such as one year) is, or is approximately, or is estimated to be, $1 Million dollars; and ii) a record with Buyer C populated to the Buyer ID field 142, 1.75% populated to the rate field 143 indicating that a network fee rate of 1.75% applies to payments made by Buyer C to Vendor A, and $1.5 Million populated to a spend field 145 indicating that aggregate payments from Buyer C to Vendor A over a predetermined period of time (such as one year) is, or is approximately, or is estimated to be, $1.5 Million dollars.

Similarly, the record 128 associated with Vendor C may associate with buyer rate records 141b. The buyer rate records 141b include: i) a record with Buyer A populated to the Buyer ID field 142, 1.00% populated to the rate field 143 indicating that a network fee rate of 1.00% applies to payments made by Buyer A to Vendor C, and $1.5 Million populated to a spend field 145 indicating that aggregate payments from Buyer A to Vendor C over a predetermined period of time (such as one year) is, or is approximately, or is estimated to be, $1.5 Million dollars; ii) a record with Buyer B populated to the Buyer ID field 142, 2.00% populated to the rate field 143 indicating that a network fee rate of 2.00% applies to payments made by Buyer B to Vendor C, and $0.5 Million populated to a spend field 145 indicating that aggregate payments from Buyer B to Vendor C over a predetermined period of time (such as one year) is, or is approximately, or is estimated to be, $0.5 Million dollars; and iii) a record with Buyer F populated to the Buyer ID field 142, 0.50% populated to the rate field 143 indicating that a network fee rate of 0.50% applies to payments made by Buyer F to Vendor C, and $3 Million populated to a spend field 145 indicating that aggregate payments from Buyer F to Vendor C over a predetermined period of time (such as one year) is, or is approximately, or is estimated to be, $3 Million dollars. It should be appreciated that the rate on payments from Buyer A to Vendor A is different than the rate on payments from Buyer A to Vendor C.

Turning to FIG. 4b in conjunction with FIG. 1, the database 118 may include a buyer registry 114. The buyer registry 114, may comprise a group of buyer records 120. Each record 120 is associated with, and identifies a unique one of the buyers 14a-14f of the community of buyers 14 by inclusion of a unique system ID (for example Buyer A, Buyer B, Buyer C) within a system ID field 122 of the record.

Also associated with the Buyer may be: i) the buyer's name included in a name field 146; ii) the buyer's tax identification number included in a tax ID field 147; iii) the buyer's contact information included in a contact information field 148; and v) the buyer's transaction or funding account identifier included in a funding account information field 124.

The buyer's name 146 may be the official name of the entity as recorded in official records of the jurisdiction in which it is formed and as used for titling its bank accounts, including its funding account.

The buyer's contact information 148 may include the name of an individual in the buyer's accounts payable department responsible for managing the buyer's accounts payable matters with the vendors 12.

The buyer's funding account identifier 140 may identify the bank at which the buyer's funding account is held (which is not necessarily the participating bank with which the buyer is associated) such as by an ABA routing number, an account number, and/or other information needed by the payment system 20 and/or settlement network 32 to execute transactions to fund the bank's pooling account 34a, 34b from the buyer's funding account in accordance with payment authorization instructions provided by a buyer.

Each record of the buyer registry 114 may be associated with a unique buyer vendor group table 149, for example the record for buyer 14a (with buyer ID “Buyer A”) may be associated with buyer vendor group table 149a and the record for buyer 14b (with buyer ID “Buyer B”) may be associated with buyer vendor group table 149b.

Buyer vendor group table 149a, associated with buyer 14a, may include identification of buyer 14a, and a vendor ID for each vendor in Buyer 14a's unique buyer vendor subgroup. More specifically, the buyer vendor group table 140a may include a group of records 153a with each record being unique to one of the vendor's within buyer 14a's buyer vendor subgroup.

Each record 153a may include a vendor ID within a vendor ID field 150a which identifies the vendor and associates the record with the vendor. For example, buyer 14a's buyer vendor subgroup may consists of six (6) vendors, vendor 12a, vendor 12b, vendor 12c, vendor 12e, vendor 12g, and vendor 12i, which is fewer then all vendors within the community of vendors 12.

The buyer vendor group table 149a also associates each vendor with a transaction rate that applies to payments from Buyer 14a to the vendor. More specifically, a transaction rate may be specified as a percentage or fractional value within a transaction rate field 151a of the record 153a associated with the vendor. For example, identification of zero percent (0.00%) is associated with identification of Vendor 12a indicating that a transaction rate of zero percent (0.00%) applies to payments from Buyer 14a to Vendor 12a. A transaction rate of one half percent (0.50%) is associated with identification of Vendor 12b, a transaction rate of one and one quarter percent (1.25%) is associated with identification of Vendor 12c, and Vendor 12e, a transaction rate of one and three quarters percent (1.75%) is associated with identification of Vendor 12g, and a transaction rate of two and one quarter percent (2.25%) is associated with identification of vendor 12i.

The buyer vendor group table 149a also associates each vendor with a spend value within a spend field 153a. The spend value represents the aggregate amounts of payments made by the buyer, or expected or estimated to be made by the buyer, to the vendor during a predetermined period of time such as one year.

For example, identification of $1 million is associated with identification of Vendor 12a indicating that Buyer 14a pays, or is estimated or expected to pay, Vendor 12a a total of $1 million over the predetermined period of time. A spend value of $1.25 million is associated with identification of Vendor 12b indicating Buyer A pays, or is estimated or expected to pay, Vendor 12b a total of $1.25 million over the predetermined period of time. A spend value of $1.5 million is associated with identification of Vendor 12c. A spend value of $1.25 million is associated with identification of Vendor 12e. A spend value of $0.5 million is associated with identification of Vendor 12g. A spend value of $0.75 million is associated with identification of Vendor 121.

Buyer 14b's buyer vendor subgroup may consists of six (6) vendors, vendor 12a, vendor 12b, vendor 12c, vendor 12f, vendor 12h, and vendor 12j, which is fewer then all vendors within the community of vendors 12. Within the vendor group table 149b, each of such vendors is associated with a unique record that includes the Vendor ID within the vendor ID field 150b.

The buyer vendor group table 149b also associates each vendor with a transaction rate that applies to payments from Buyer 14b to the vendor. More specifically, a transaction rate may be specified as a percentage or fractional value within a transaction rate field 151b of the record 153b associated with the vendor.

For example, identification of a transaction rate of zero (0.00%) is associated with identification of Vendor 12a, a transaction rate of three quarters of a percent (0.75%) is associated with identification of Vendor 12b, a transaction rate of one and one half percent (1.50%) is associated with identification of Vendor 12c, a transaction rate of three percent (3.00%) is associated with identification of Vendor 12f and Vendor 12h, and a transaction rate of two and one quarter percent (2.25%) is associated with identification of vendor 12j.

The buyer vendor group table 149b also associates each vendor with a spend value within a spend field 153b. The spend value represents the aggregate amounts of payments made by the buyer, or expected or estimated to be made by the buyer, to the vendor during a predetermined period of time such as one year.

For example, identification of $1 million is associated with identification of Vendor 12a indicating that Buyer B pays, or is estimated or expected to pay, Vendor 12a a total of $1 million over the predetermined period of time. A spend value of $1.5 million is associated with identification of Vendor 12b indicating Buyer B pays, or is estimated or expected to pay, Vendor 12b a total of $1.5 million over the predetermined period of time. A spend value of $0.5 million is associated with identification of Vendor 12c. A spend value of $0.75 million is associated with identification of Vendor 12f. A spend value of $2 million is associated with identification of Vendor 12h. A spend value of $3 million is associated with identification of Vendor 12j.

Turning to FIG. 4c in conjunction with FIG. 1, the database 118 may include an invoice database 160 comprising a group of records 162. Each record 162 associates a unique invoice ID 164 with a unique invoice object 166 and a group of at least three status fields. In the exemplary embodiment, the status fields include an invoice received status field 168, a pending approval status field 170, an approved status field 172, a set for payment status field 174, a first approved to pay status field 176a, a second approved to pay status field 176b, a payment initiated status field 178, and a disputed invoice status field 180.

Each status field represents a completed step within a group of processing steps the buyer performs to approve and pay the invoice, whether within the invoice application 19 itself or within the buyer's accounts payable system 43 (FIG. 2) represented by the record 162.

The invoice received status field 168 may represent an initial step wherein the buyer has completed receipt of the invoice into its accounts payable system.

The pending approval status field 170 may represent steps following receipt of the invoice which are performed by the buyer prior to formal approval of the invoice.

The approved status field 172 may represent formal approval of the invoice. The set for payment status field 174 may represent a step of setting the payment of the invoice. The first approved to pay status field 176a may represent approval of the payment. The second approved to pay status field 176b may be an optional step representing a second level approval of the payment. The optional step 176b may apply based on buyer's approval rules, for example high value payments may require a second level of approval. The payment initiated status field 180 may represent the buyer initiating the payment through the system 10 by issuing a payment file (described with respect to FIG. 9a-9c). The disputed status field 180 may represent the buyer disputing all or a portion of the invoice.

Each status field operates as a status flag for that processing step in that whether the value populated, or whether a particular value populated, indicates whether the processing step has been completed by the buyer. In the exemplary embodiment, each of the status fields 168, 170, 172, 174, 176a, 176b, and 178 may be populated with the date that the process was completed by the buyer.

Turning briefly to FIG. 4d, an exemplary invoice object 166 may comprise a header 182 and a body 184. The header 182 may include a vendor ID 186 and a buyer ID 188 identifying the vendor (by system ID 130) issuing the invoice and identifying the buyer (by system ID 122) to which the invoice is to be delivered.

The body 184 of the invoice object includes invoice data. The invoice data may comprise data components of a standardized XML data schema 190—which may be an invoice data schema standardized by the ISO 20022 standard. The invoice data may also include attachments 192 which would typically be PDF files but could be attachments in other file formats which provide more detailed information about invoice line items.

Returning to FIG. 4c, within the records 162 of the invoice database 160 are at least a first invoice object (Invoice ID 001 for example) which includes identification of a first vendor (Vendor A for example) and at least a second invoice object (Invoice ID 003 for example) which includes identification of a second vendor (Vendor B for example) unique from the first vendor. Each vendor is a distinct organization with responsibility for issuing and collecting on its own invoices.

Also within the records 162 of the invoice database 160 are at least a first invoice object (Invoice ID 001 for example) which includes identification of a first buyer (Buyer B for example) and at least a second invoice object (Invoice ID 002 for example) which includes identification of a second buyer (Buyer C for example) unique from the first buyer. Each buyer is a distinct organization with responsibility for payment of invoices distinct from other buyers.

For example, the record 162 with an invoice ID 164 of “001” may include an invoice 166 issued by Vendor A to Buyer B. For purposes of illustrating the invention, it is assumed that all processes have been completed and a date is populated to each field. A second level approval step 176b is not required.

The record 162 with an invoice ID of “002” may include an invoice 166 issued by Vendor A to Buyer C. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required.

The record 162 with an invoice ID of “003” may include an invoice 166 issued by Vendor A to Buyer D. For purposes of illustrating the invention, it is assumed that Buyer D has a dispute regarding this invoice. As such only a date is populated to the invoice received status field 168 and a dispute code “Code 1” is populated to the disputed field.

Turning briefly to FIG. 4e, an exemplary dispute code table 300 may associate a group of dispute codes 302, for example dispute codes “Code 1”, “Code 2”, “Code 3”, and “Code 4”. Each code 302 may represent a dispute reason 304. For example, “Code 1” may represent dispute a first reason “Reason A” and “Code 2” may represent a second dispute reason “Reason B”, which is distinct from dispute “Reason A”. A fourth dispute reason “Code 4” may be generic and represent buyer text input of a message to the vendor regarding the basis for the dispute.

Returning to FIG. 4c, the record 162 with an invoice ID of “004” may include an invoice 166 issued by Vendor B to Buyer A. For purposes of illustrating the invention, it is assumed that Buyer A has performed only the first two sequential processing steps (invoice received 168 and pending approval 170). As such, dates are populated for invoice received 168 and pending approval 170. A second level approval step 176b is required for this invoice.

The record 162 with an invoice ID of “006” may include an invoice 166 issued by Vendor A to Buyer B. For purposes of illustrating the invention, it is assumed that Buyer C has performed only the first three sequential processing steps (invoice received 168, pending approval 170, and pending approval 172). As such, dates are populated for invoice received 168, pending approval 170 and pending approval 172. A second level approval step 176b is not required. As will be discussed herein, for this invoice it will be assumed that an exception condition exists with respect to the next sequential step (Set for Payment 174).

The record 162 with an invoice ID of “007” may include an invoice 166 issued by Vendor A to Buyer F. For purposes of illustrating the invention, it is assumed that the second level approval step 176b is required and that Buyer F has performed all of the sequentially processing steps, including second level pending approval to pay 176b, except for the payment initiated Step 178. As such, dates are populated for invoice received 168, pending approval 170, pending approval 172, set for payment 174, first level pending approval to pay 176a, and second level pending approval to pay 176b.

Returning to FIG. 1, the invoice presentment and payment system 10 may include an invoice application 19 and a payment application 18, each of which may be instructions coded to computer readable media and executed by the processor.

In general, the invoice application 19 delivers invoices initiated by each vendor of the community of vendors 12 to the applicable buyer and includes a reporting function which provides a vendor connecting to the system 10 with proper access credentials (a connecting vendor) with invoice approval and payment status in an graphical format.

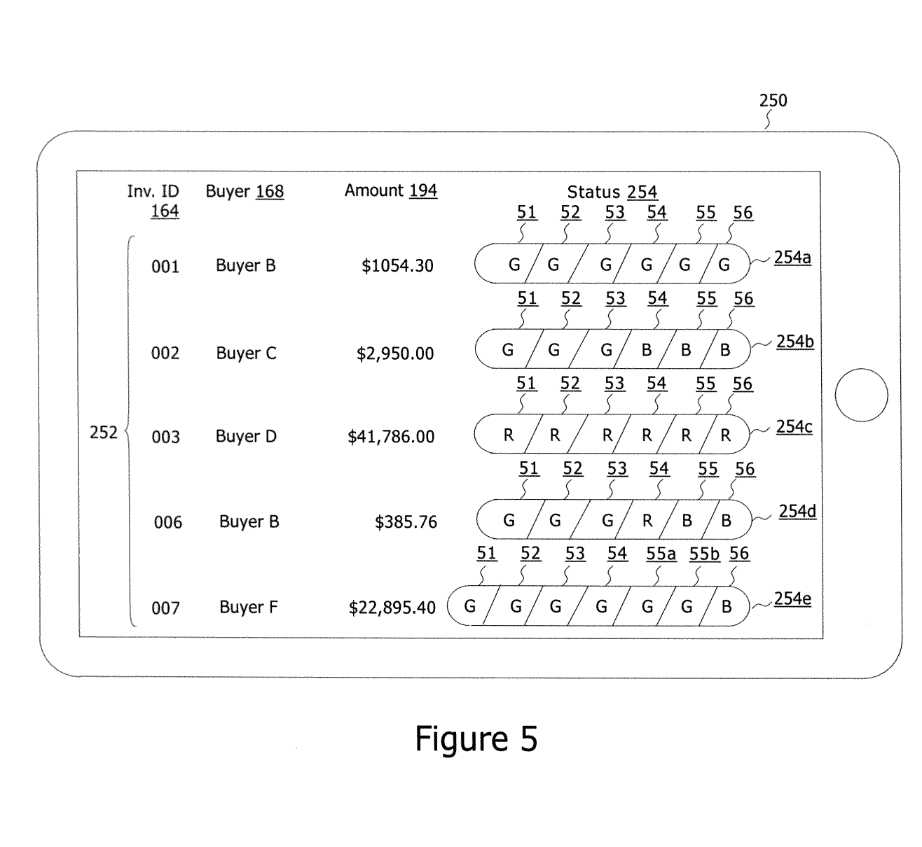

For purposes of reporting invoice approval and payment status to each connecting vendor, the invoice application 19 may store an invoice report template 249. FIG. 5 is a graphic depicting the invoice template as populated as an exemplary invoice report 250 as it may be rendered on a portable tablet computer by an application compatible with the system 10 or as it may be rendered by an ordinary web browser connecting to the system 10.

The report 250 includes a group of horizontal rows 252, each row representing a unique one of the group of invoices issued by the connecting vendor. Each row comprises, from the database, the invoice identifier 164, the buyer ID 168, invoice amount 194, and a multi-segment status control 254.

The multi-segment status control 254, using control 254a as an example, includes a group of six segments 51-56 arranged lineally within the horizontal row. Each segment 51-56 represents a unique one of the steps the buyer preforms to approve and pay an invoice. For example, referring to FIG. 5 in conjunction with FIG. 4c: i) segment 51 corresponds to invoice received status (field 168); ii) segment 52 corresponds to the pending approval status (field 170); iii) segment 53 corresponds to the invoice approved status (field 172); iv) segment 54 corresponds to the set for payment status (field 174); v) segment 55 corresponds to the approved to pay status (field 176a) and vi) segment 56 corresponds to the payment initiated status (field 180). The multi-segment status control 254a does not include a segment for the second level approved to pay status (field 176b) and is therefore used for reporting status of invoices that do not required second level payment approval.

A second multi-segment status control 254, using control 254e as an example includes a group of seven segments 51, 52, 53, 54, 55a, 55b, and 56 arranged linearly within the horizontal row. Each segment 51, 52, 53, 54, 55a, 55b, and 56 represents a unique one of the steps the buyer preforms to approve and pay the invoice. For example, referring to FIG. 5 in conjunction with the row 162 representing invoice ID 007 of FIG. 4c: i) segment 51 corresponds to invoice received status (field 168); ii) segment 52 corresponds to the pending approval status (field 170); iii) segment 53 corresponds to the invoice approved status (field 172); iv) segment 54 corresponds to the set for payment status (field 174); v) segment 55a corresponds to the first level approved to pay status (field 176a), vi) segment 55b corresponds to the approved to the second level pay status (field 176b), and vii) segment 56 corresponds to the payment initiated status (field 180). The multi-segment status control 254b includes a segment for the second level approved to pay status (field 176b) and is therefore used for reporting status of invoices that required second level payment approval.

Each segment is a first color (such as blue) if the segment represents a processing step that the buyer has not yet performed for the invoiced identified in the row. Each segment is a second color (such as green) distinct from the first color if the segment represents a processing step that the buyer has already performed for the invoice.

For example, referring to multi-segment control 254a which represents the status of the invoice with invoice ID 001 of FIG. 4c, each segment 51-56 is the second color (green) indicating that all steps have been performed.

Referring to multi-segment control 254b which represents the status of the invoice with invoice ID 002 of FIG. 4c, each of the first three segments 51, 52, and 53 are the second color (green) indicating that the first sequential steps (invoice received 168, pending approval 170, and approval 172) have been performed. The remaining segments 54, 55, and 56 are the first color (blue) indicating that those steps have not yet been performed.

Referring to multi-segment control 254c, which represents the status of the invoice with invoice ID 003 of FIG. 4c, all segments are the third color (red) indicating that the invoice status is in dispute. As will be discussed on more detail, each exception segment (red) is also an active link which, when selected by the user, opens a pop-up window which indicates the exception. Similarly, when the entire control is the third color (red) it is also an active link which, when selected by the user, opens a pop-up window which indicates the basis for the dispute if available.

Referring to multi-segment control 254d which represents the status of the invoice with invoice ID 006 of FIG. 4c, each of the first three segments 51, 52, and 53 are the second color (green) indicating that the first sequential steps (invoice received 168, pending approval 170, and approval 172) have been performed. Segment 54 is the third color (red) indicating that the set for payment step 174 has not been performed and that an exception condition exists. The remaining segments 55 and 56 are the first color (blue) indicating that those steps also have not yet been performed. The segment 54 which is the third color (red) is also an active link which, when selected by the user, opens a pop-up window which indicates the exception condition.

Referring to multi-segment control 254e which is the seven-segment control represents the status of the invoice with invoice ID 007 of FIG. 4c, each of the segments 51, 52, 53, 54, 55a, and 55b are the second color (green) indicating that the that those steps, including second level approval 176b have been performed. The only remaining segment 56 is the first color (blue) indicating that the payment initiated step 178 has not been performed.

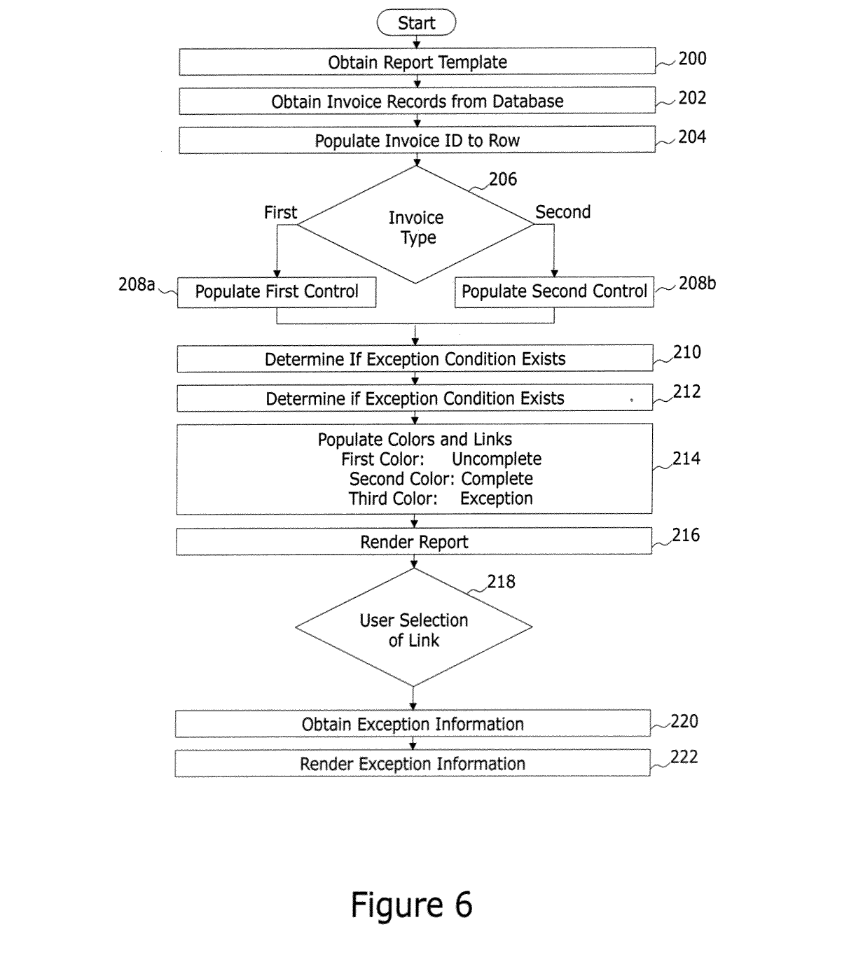

Turning to FIG. 6 in conjunction with FIG. 5, exemplary processing steps of the invoice application 19 are shown. The steps may be performed in response to a connecting vendor 12 using applicable access credentials to obtain an invoice report 250.

Step 200 represents obtaining the invoice template 249 stored by the invoice application 19 in computer readable memory for populating for purposes of rendering the invoice report 250. In the event the connecting vendor 12 is connecting using a web browser, the template 249 may be a web page template. In the event the connecting vendor is using a tablet or other form of application which includes its own rendering capabilities, the template 249 may be an XML schema for provision of the invoice information to the application for rendering.

Step 202 represents obtaining, from the invoice database 160 (FIG. 4c), those records for which the connecting vendor 12 is the vendor identified by the vendor ID 186 for the invoice object 166. It should be appreciated that Step 202 may represent only obtaining a portion of such invoices in the event that the connecting vendor provides parameters for limiting the quantity of invoices to be represented on the report. Such parameters may include date parameters for limiting invoices by date or status parameters for limiting invoices based on status.

Steps 204 through 214 represent populating each row of the report. Step 204 represents populating the invoice ID to an invoice ID filed 164 of the row of the report 250.

Step 206 represents determining the invoice type. More specifically step 206 represents determining whether the invoice is of a first type for which the first multi-segment control (with 6 segments) will be populated to the row or if the invoices is of the second type for which the second multi-segment control (with 7 segments) will be populated to the row. More specifically, step 206 may represent comparing characteristics of the invoice with approval rules 150 (FIG. 4b) applicable to the buyer. For example, if the approval rules 150 include a threshold value for when a second level approval is required, comparing the invoice characteristics to the approval rules may include comparing the invoice value to the threshold value. If the invoice value is below the threshold value second level approval is not required and the first multi-segment control (with 6 segments) may be populated at step 208a. Alternatively, if the invoice value is greater than the threshold value then second level approval is required and the second multi-segment control (with 7 segments) may be populated at step 208b.

Step 210 represents determining the invoice status by looking up the status from the record 162 of the invoice database 160 (FIG. 4c) or, more specifically, looking up, for each sequential step in the invoice approval and payment process, whether the buyer has completed the process by way of looking up whether the field 168 to 178 associated with that process indicates completion.

Step 212 represents determining whether an exception condition exists for any of the processes or if the invoice is in dispute.

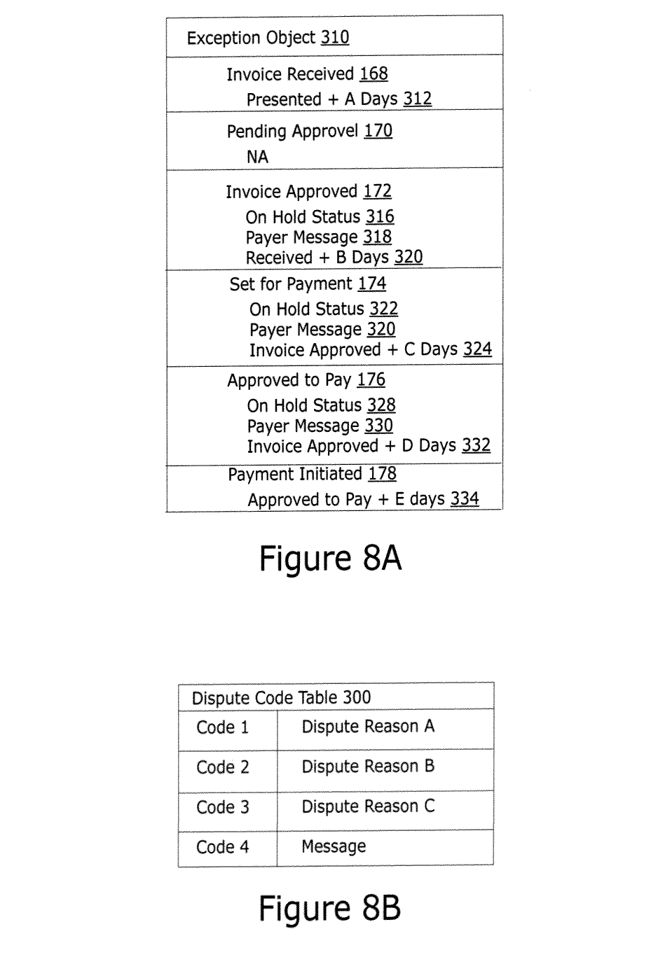

Turning briefly to FIG. 8a in conjunction with FIG. 1, the invoice application 19 may include an exception object 310 for purposes of determining whether an exception exists at each step in the process. An exemplary exception object 310 includes, for each process, at least one rule for determining exception status. For example, for the invoice received 168, a time based rule 312 may be “invoice presented plus X days” indicating an exception exists if X days have elapsed since the invoice was presented.

For invoiced approved 172 there may be three exemplary rules for determining if an exception condition exists. A first rule 316 may be a rule which indicates that if the buyer has put the invoice “on-hold”, an exception status exists. A second rule 318 may be a rule which indicates that if the buyer has messaged the buyer, an exception status exists. A third rule 320 may be a time based rule such as “invoice received plus Y days” indicating an exception exists if a Y days have elapsed since the invoice has achieved invoiced received status. This time based rule keys off of a previous event status.

For set for payment status 174 there may be three exemplary rules for determining if an exception condition exists. A first rule 322 may be a rule which indicates that if the buyer has put the invoice “on-hold”, an exception status exists. A second rule 324 may be a rule which indicates that if the buyer has messaged the buyer, an exception status exists. A third rule 326 may be a time based rule such as “invoice approved plus C days” indicating an exception exists if a C days have elapsed since the invoice has achieved invoice approved status.

For approved to pay status 176a or 176b there may be three exemplary rules for determining if an exception condition exists—which apply to status 176a if second level approval is not required and apply to status 176b if second level approval is required. A first rule 328 may be a rule which indicates that if the buyer has put the invoice “on-hold”, an exception status exists. A second rule 330 may be a rule which indicates that if the buyer has messaged the buyer, an exception status exists. A third rule 332 may be a time based rule such as “invoice approved plus D days” indicating an exception exists if a D days have elapsed since the invoice has achieved invoice approved status.

For payment initiated status 178 there may be one exemplary rule for determining if an exception condition exists. The rule 334 may be a time based rule such as “approved to pay plus E days” indicating an exception exists if a E days have elapsed since final approval to pay (176a or 176b, if second level approval is required).

Returning to FIG. 6, in more detail step 212 represents determining whether an exception condition exists for any processing by comparing the status of the buyer's approval, and events within the approval process, as recorded in the invoice database 160 (FIG. 4c) to the exception conditions and, if there is a match, the exception condition exists.

Step 214 represents populating colors to the multi-segment status control as follows: i) populating the first color (green) to each segment representing a processing step that has not been completed; ii) populating the second color (blue) to each segment representing a processing step that has been completed; iii) populating a third color (red) to any segment representing a step that is in exception status; and iv) populating the third color (red) too all segments of the multi-segment status control in the event the invoice status is disputed (field 180 of the invoice database 160, FIG. 4c). Those segments which are populated in the third color are also active links which, when selected by the user, opens a pop-up window which provides information about.

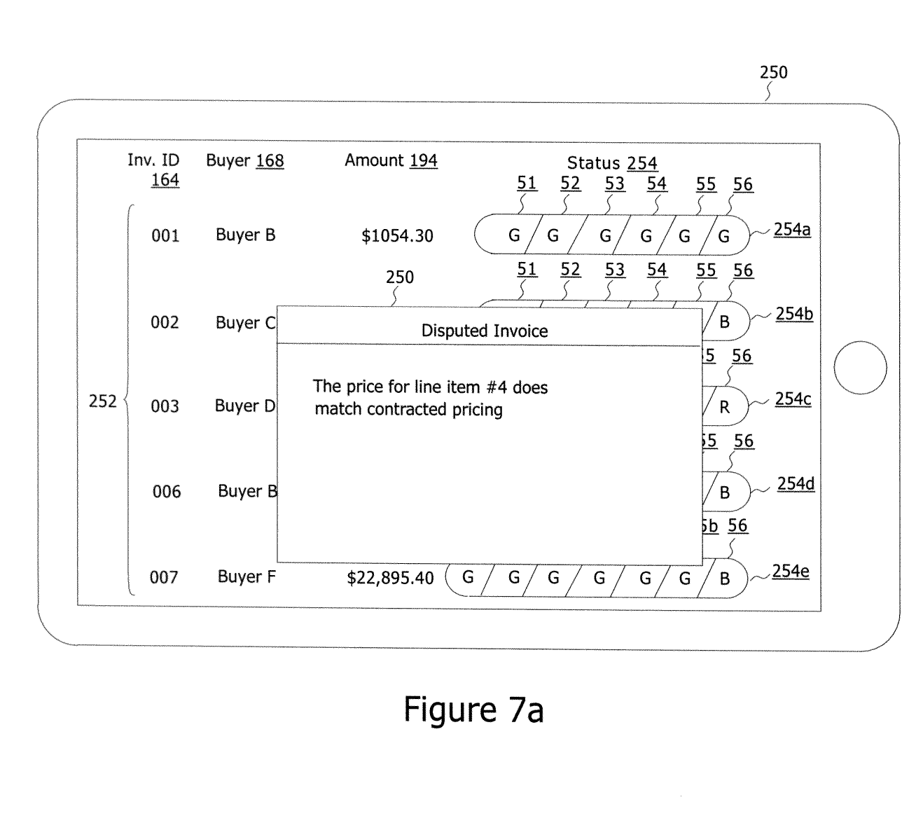

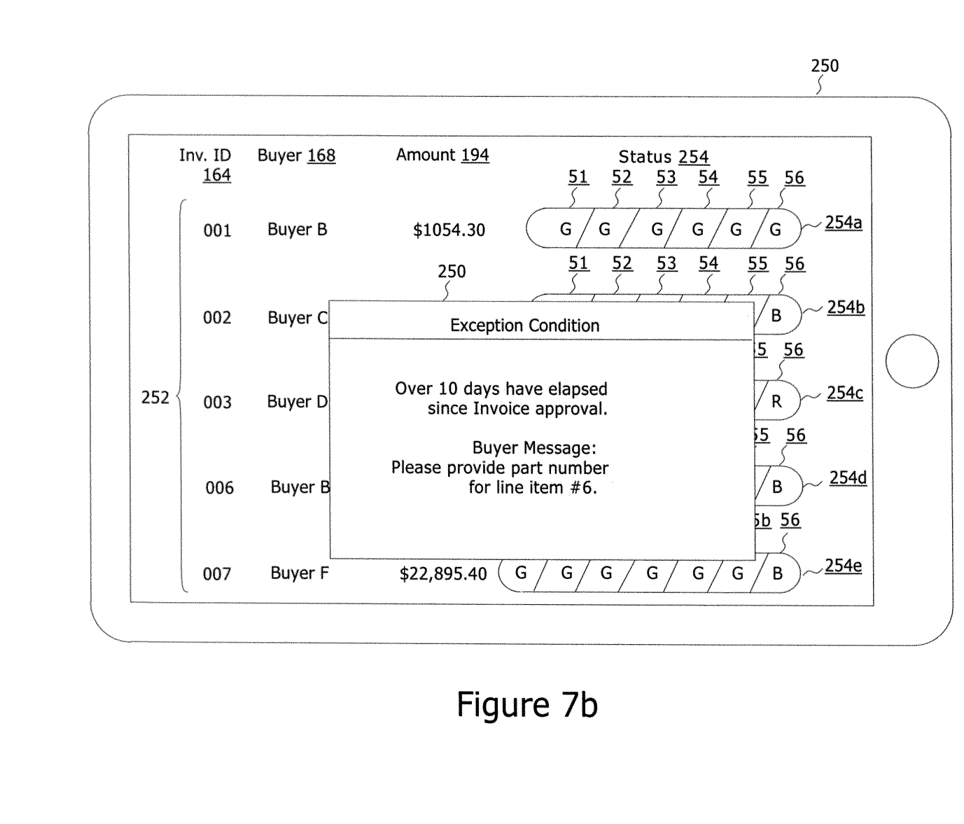

For example, referring briefly to FIG. 7a, upon selection of a third colored segment, a pop-up window may display the exception condition such as X days have elapsed since the invoice was presented (exception condition 312, FIG. 4d).

Similarly, referring briefly to FIG. 7b, upon selection of a third colored segment, a pop-up window may display the buyer input message (exception condition 318, FIG. 4d).

After steps 206 through 214 are complete for all rows of the report (all invoices within the database with a vendor ID matching that of the connecting vendor and within selection criteria provided by the connecting vendor), step 216 represents rendering the report on user interface of the device used by the connecting vendor such as the work station browser 61a or the tablet computer 61b (FIG. 3).

As discussed, if an exception condition exists (invoice in dispute or an exception condition at any step), the segment of the third color (red) is an active link. Step 218 represents user selection of a link within one of the segments of the third color (red). Referring to FIG. 7a, upon user selection of the link, a pop-up window 255 is rendered at step 222 to indicate the exception condition.

More specifically, if the exception condition is a dispute, the dispute code from field 180 of the record 162 for the invoice (FIG. 4c) is read and the basis for the dispute is read from a dispute code table 300 as shown in FIG. 8b. The basis for the dispute corresponding to the dispute code is then populated to the pop-up window. For example, if the dispute code is “Code 1”, the basis “Dispute Reason A” would be populated to the pop-up window. If the dispute code is “Code 4”, the dispute reason does not match any of the other codes but is instead based on other criteria described in a message from the buyer. Turning briefly of FIG. 4c, associated with each record that includes dispute “Code 4” in the dispute field 180 is a text field 181 (FIG. 4c) which includes a text based basis for the dispute which may be input by the buyer. As represented in FIG. 7a, the text is then populated to the pop-up window 255.

If the exception condition is related to a particular step, for example the set for payment step 174 for invoice ID 006 (FIG. 4c), the basis (or multiple basis) for the exception is (are) populated to the pop-up window 255. For example, referring to FIG. 4f, if the exception condition is both: i) a buyer message 330; and ii) over D days have elapsed since invoice approval 332; information about both are populated to the pop-up window. Again turning briefly of FIG. 4c, associated with each record that includes a buyer message exception condition, is a text field 181 which includes a text based message for the exception condition which may be input by the buyer. As represented in FIG. 7, the text based basis is then populated to the pop-up window 255.

It should be appreciated that steps 220 and 224 may be implemented as code within the report 250 such that if the report 250 is rendered on a browser, the browser has the capability to generate the pop-up window without a new call or connection to the system 10. Similarly, steps 220 and 224 may be implemented as code within the mobile device such that the mobile device application may render the pop-up window without a new call or connection to the system 10.

Returning to FIG. 1 the Payment Initiated step 178 (FIG. 4c) may represent the buyer initiating payment to the vendor utilizing the payment application 18 of the system 10. More specifically the invoice presentment and payment system 10 receives a payment instruction file identifying payments to process for the buyer, such payment may be on one or more invoices represented by a records 162 of the invoice database 160 (FIG. 4c) that are at the Approved to Pay status 176a, 176b.

Referring to FIG. 9a a first exemplary payment instruction data structure, or payment instruction file, that would be received from a buyer 14 is depicted. Referring to FIG. 1 in conjunction with FIG. 9a, the payment instruction file 160a may comprises identification of the buyer within a buyer ID field 162 (Buyer ID “Buyer A” representing buyer 14a) and, associated with that buyer ID field 152, a group of unique records 172, each record representing a unique payment instruction. Each record 172 includes: i) identification of the vendor to which payment is to be made by inclusion of the vendor's Vendor ID (from the vendor registry 112) within a vendor ID field 164; ii) identification of the amount of the payment to be made to the vendor by inclusion of a payment amount within a payment amount field 166; and iii) remittance information, which may be alpha numeric information identifying what payable is being paid, within a remittance string field 170. The remittance information may identify the vendor's invoice being paid, goods or services for which payment is being made, or other aspects of an underlying transaction between the buyer and vendor giving rise to the payment associated with the record.

FIG. 9b represents a second exemplary payment instruction data structure, or payment instruction file that would be received from a buyer 14. Referring to FIG. 1 in conjunction with FIG. 9b, the payment instruction file 160b may comprise a group of unique records 172, each record representing a unique payment instruction. Each record 172 includes: i) identification of the buyer within a buyer ID record 162 (i.e. Buyer ID “Buyer B” representing buyer 14b)); ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the buyer and vendor giving rise to the payment associated with the record.

FIG. 9c represents a third exemplary payment instruction data structure, or payment instruction file that would be received from a buyer 14. Referring to FIG. 1 in conjunction with FIG. 9c, a group of independent payment instructions, comprising unique payment instructions 161a, 161b and 161c, may in the aggregate be a payment instruction file 160c.

Each payment instruction may include: i) identification of the buyer within a buyer ID record 162; ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the buyer and vendor giving rise to the payment associated with the record.

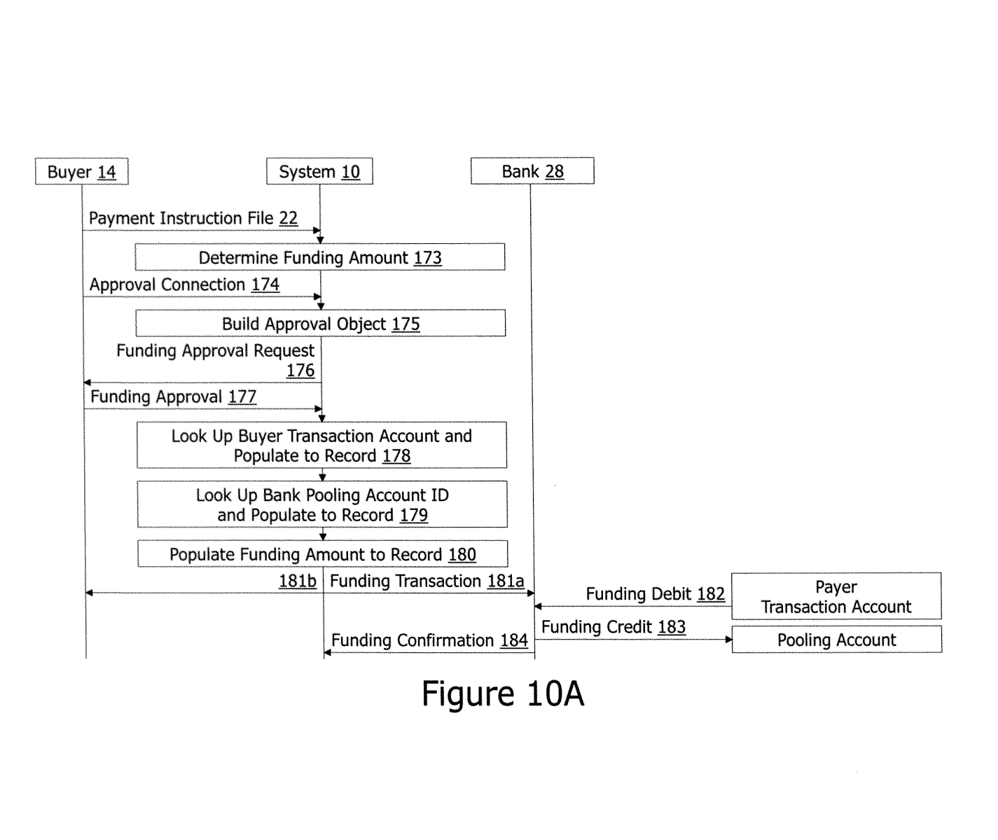

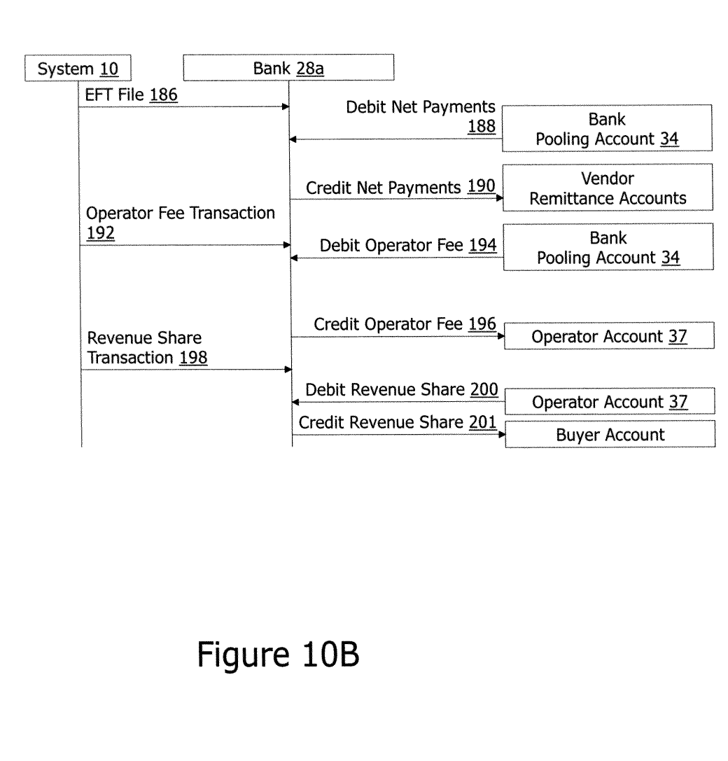

Referring to the ladder diagram of FIG. 10a in conjunction with FIG. 1, in an exemplary embodiment of operation, the invoice presentment and payment system 10 receives a payment instruction file from a buyer 14a-14f. For example, payment instruction file 160a (FIG. 9a) may be received from buyer 14a, as represented by step 22. The payment instruction file 160a, 160d may be transferred via a secure connection over the network 20 which may include implementing encryption of the connection and/or the file transferred over the connection.

Upon receiving and authenticating the payment instruction file 160, the invoice presentment and payment system 10, or more specifically, the processor 40 executing the payment application 18, determines a funding amount at step 173. The funding amount is equal to the aggregate or sum of the amount of all payments to be disbursed by the buyer as represented in the payment instruction file 160.

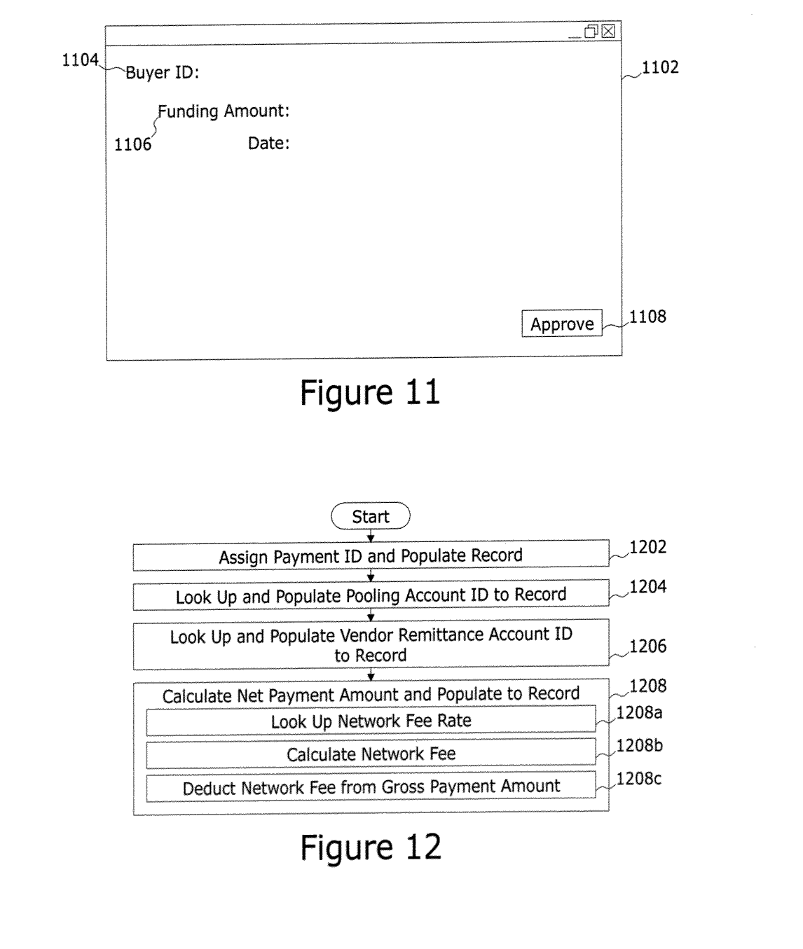

Steps 174 through 177 represent obtaining the buyer's approval of the funding amount. More specifically, in response a buyer system 49a, 49b, 49c establishing a secure session with the system 10 for purposes of approving the funding total (as represented by step 174), the system 10, at step 175, generates a funding approval object (for example object 1102 as represented by FIG. 11) by looking up the funding total calculated for the buyer. Step 176 represents providing the funding approval object to the buyer system 49a, 49b, 49c for rendering, authentication, and approval by the buyer. Step 177 represents posting of the buyer's approval to the system 10.

Referring briefly to FIG. 11, the exemplary funding approval object, represented in graphic form as may be rendered on the remote buyer system 49a, 49b, or 49c, may comprise a least identification of the buyer 1104, identification of the funding amount 1106, and a control 1108 operational for posting the buyer's approval to the system 10.

Returning to FIG. 10a, steps 178 through 184 represent generating a funding transaction to fund the transfer of the funding total from the buyer's account to the pooling account of the participating bank with which the buyer is associated. More specifically, generating the funding transaction comprises: i) at step 178, looking up the buyer's funding account identifier 124 in the buyer registry 112 (FIG. 4b) and populating the funding account identifier to a field of the funding transaction which identifies the account to be debited; ii) at step 179, looking up the bank's pooling account identifier and populating the pooling account identifier to a field of the funding transaction which identifies the account to be credited; and iii) at step 180, populating the approved funding amount to a field of the funding transaction which represents the amount to transfer (debit and credit).

Step 181 represents sending the funding transaction to the bank 28 for execution. Execution is represented by debiting the approved funding amount from the buyer's transaction account at step 182 and crediting the bank's pooling account at step 183. Step 184 represents the bank confirming to the system 10 that the funding transaction is complete and that the approved amount has been deposited into the pooling account.

The debit of the buyer's account and credit to the pooling account may be by funds transfer if both accounts are held at the same bank, by transfer through a settlement network 32 (for example via ACH or Wire) if the buyers account and the pooling account are held at different banks. As discussed, the settlement network 32 may be separate from the invoice presentment and payment system 10, such as the Fedwire settlement network or the ACH settlement network, or may be a proprietary component of the invoice presentment and payment system 10, such as a bank card association settlement network. In an embodiment wherein the settlement network 32 is part of the invoice presentment and payment system 10, the settlement network 32 may be an application comprising instructions stored on the computer readable medium 42 and executed by processor 40, such instructions implementing the credit and debit transactions as described in this specification.

In a second funding embodiment, the funding instruction 181b may be a message to the buyer from which the payment instruction file was received. The buyer may then, accessing a payment system 30 at the buyer's bank or a settlement network 32, initiate a debit transaction to debit the funding amount from buyers account and initiation of a credit transaction to credit the funding amount to the pooling account. Again thereafter, step 184 represents the participating bank confirming to the system 10 that the funding transaction is complete and that the approved amount has been deposited into the pooling account. After confirmation that the funding amount from the buyer has been received in the bank's pooling account, payments are disbursed to vendors.

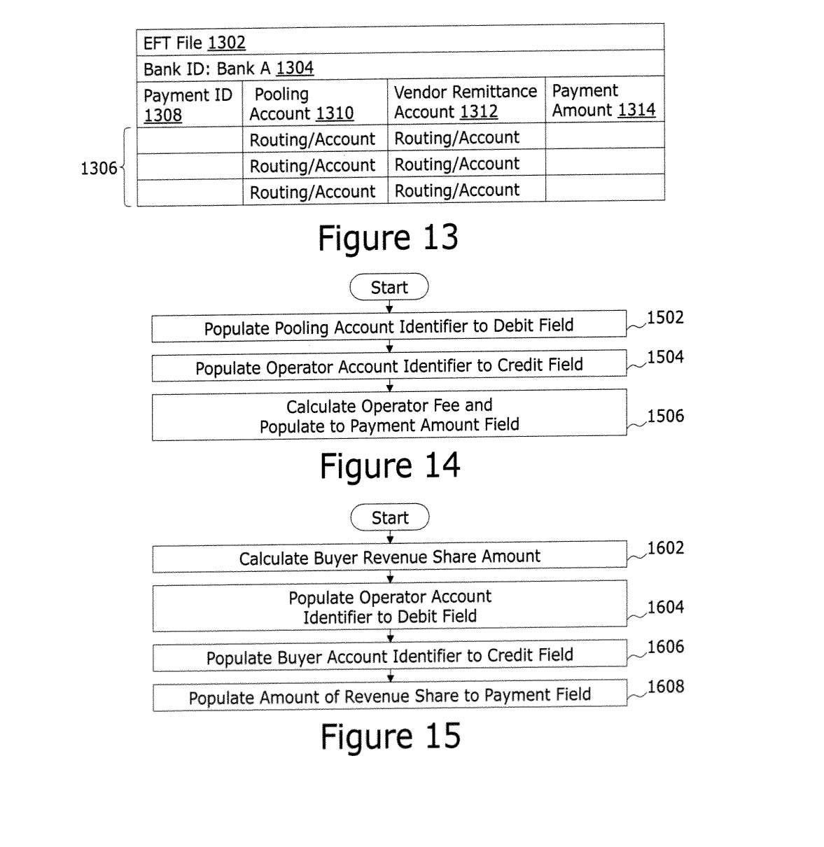

The steps of FIG. 12 represent operation of the application 18 to generate an electronic funds transfer (EFT) file 1302 depicted in table format in FIG. 13. The EFT file 1302 comprises a group of records 1306. Each record represents a single payment of a disbursing buyer to a payee. The records of the EFT file may represents payments from multiple disbursing buyers. The EFT file 1302 may include an identifier of the bank 1304.

Each payment record 1306 includes at least: i) a payment ID field 1308 which is populated with a unique value to identifying the payment; ii) a field identifying the account to be debited 1310 populated with the bank's pooling account identifier (i.e. ABA routing number and account number of the pooling account); iii) a field identifying the account to be credited 1312 populated with the vendor's remittance account identifier (i.e. ABA routing number and account number of the vendor's remittance account 140, FIG. 4a); and iv) a payment amount field 1314 populated with the amount of the payment to be debited from the participating bank's pooling account and credited to the vendor's remittance account.

Turning to FIG. 12 in conjunction with FIG. 13, generating each EFT file 1302 comprises, for each payment within the funding amount approved by each disbursing buyer with funds on deposit in the pooling account: i) at step 1202, assigning a unique identifying value to the payment and populating it to the payment ID field 1308 of a unique record 1306; ii) at step 1204, looking up the pooling account identifier and populating the pooling account identifier to the field identifying the account to be debited 1310; iii) at step 1206, looking up the vendor's remittance account identifier and populating the vendor's remittance account identifier to the field identifying the account to be credited 1312; and iv) at step 1208, calculating a net payment amount and populating the net payment amount to the payment amount field 1314.

Calculating the net payment amount may comprise: i) at step 1208a, looking up, in the buyer rate records 141 of the record 128 of the vendor registry 112 associated with the vendor (i.e. the record 128 with the System ID of the vendor populated to the system ID field 130) the network fee rate from the rate field 143 of the record 144 associated with the buyer (i.e. the record 144 with the System ID of the disbursing buyer populated to the buyer ID field 142); ii) at step 1208b, calculating the network fee by multiplying the gross payment amount by the network fee rate; and iii) at step 1208c, deducing the network fee from the gross payment amount to yield the net payment amount.

Referring to FIG. 10b, after the EFT file 1302 is generated, the application 18 transfers the EFT file 1302 to the bank with the pooling account from which each payment in the EFT file 1302 is to be debited at step 186.

Steps 188 and 190 represent, for each payment represented in the EFT file 1302, debiting the net payment amount from the bank's pooling account and crediting the net payment amount to the vendor's remittance account. These steps may be accomplished by way of transferring the EFT file 1302 as disbursement instructions to the Federal Reserve such that each such payment is implemented by an electronic funds transfer commonly known as an ACH payment.

The debit(s) of the pooling account and credits to the vendor's transaction account and operator account by funds transfer if between accounts held at the same bank or by transfer through a settlement network 32 if between accounts are held at different banks.

In an alternative embodiment, the disbursements instructions 188 and 190 may each be an instruction, or a debit/credit instruction pair, sent directly by the payment application 18 the settlement network 32 (whether separate from, or part of the payment system 10) to effect the initiation of a debit transaction to debit the applicable amount from the pooling account and credit the amount of the payment less the network fee to the vendor account and to credit the network fee to the operator account.

Step 192 represents providing an operator fee transaction to the originating bank for processing. The operator fee transaction may be a record in the EFT file 1302 or a separate transaction. Referring to FIG. 15, generating the operator fee transaction comprises: i) at step 1502, populating the pooling account identifier to a field of the operator fee transaction which identifies an account from which an operator fee is to be debited; ii) at step 1504, populating an operator account identifier to a field of the operator fee transaction which identifies an account held by the operator of the system and to which the operator fee is to be credited; and iii) at step 1506, populating the amount of the operator fee to a payment amount field of the operator fee transaction, the amount of the operator fee being a portion of the aggregate network fees for each payment represented in the EFT file 1302. The portion of the aggregate network fees may be 100%.

Step 194 represents executing the operator fee transaction by debiting the operator fee from the pooling account and step 196 represents crediting the operator fee to the operator account 37.

Returning to FIG. 10b, step 198 represents providing a revenue share transaction to the bank for processing. The revenue share transaction may be a record in the EFT file 1302 or a separate transaction executed after a period of time during which revenue share is accrued. Referring to FIG. 15, generating the revenue share transaction comprises: i) at step 1602, calculating a buyer revenue share amount, the buyer revenue share amount may be a portion of the operator fee; ii) at step 1604, populating the operator account identifier to a field of the revenue share transaction which identifies an account from which an revenue share amount is to be debited; iii) at step 1606, populating the buyer's transaction account identifier to a field of the revenue share transaction which identifies an account to which the revenue share amount is to be credited; and iv) at step 1608, populating the amount of the revenue share transaction to a payment amount field.

Step 200 represents debiting the revenue share amount from the operator account 37 and step 201 represents crediting the revenue share amount to the buyer's transaction account.

In summary, the present invention provides a system for electronic delivery of invoices from each vendor of a community of vendors to each buyer of a community of buyers. The system also provides each vendor with enhanced reporting capabilities which include a graphic indication of invoice approval and payment status. The system also provides for making payments from a buyer to a community of vendors, assessing a variable network fee to each vendor, and providing revenue share to each of a group of participating banks.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A payment status reporting system comprising:
a database encoded to computer readable medium, the database comprising a group of invoice objects, each invoice object comprising:
an invoice identifier;
identification of a buyer;
identification of a vendor;
invoice data; and
a status flag identifying a completed step within a group of at least three processing steps the buyer performs to approve and pay the invoice;
a invoice application comprising instructions stored in a computer readable memory and executed by a processor, the instructions comprising, in response to a vendor query, generating a report document, the report document comprising a group of horizontal rows, each row representing a unique one of the group of invoice objects from the database, each row comprising:
the invoice identifier;
a multi-segment status control comprising a group of segments arranged linearly within the horizontal row, each segment representing a unique one of the steps of the group of at least three processing steps the buyer performs to approve and pay the invoice;
each segment being a first color if the segment represents a processing step that the buyer has not yet performed for the invoice identified in the row and a second color distinct from the first color if the segment represents a processing step that the buyer has completed for the invoice identified in the row.

2. The system of claim 1, further comprising:
an exception object coded to the computer readable media, the exception object comprising, for each of the group of at least three processing steps the buyer performs to approve and pay the invoice, identification of at least one criteria for determining whether an exception condition exists for that processing step; and
the instructions of the invoice application further comprise:
for each step of the at least three processing steps, using the criteria to determining whether an exception condition exists; and
the step of generating the report comprises populating the segment of the multi-segment status control with a third color distinct from the first color and the second ii color if the exception condition exists.

3. The system of claim 2, wherein:
the document template further comprises an embedded pop-up object; and
the instructions of the invoice application further comprise:
the step of populating the segment of the multi-segment status control with the third color further comprises populating the segment with an active link; and
upon user selection of the active link, rendering a pop-up object over the report document, the pop-up object identifying the exception condition.

4. The system of claim 3, wherein:
the database further comprises, in association with each invoice object, a text field which, if populated with text by the buyer, is an exception condition for at least one step of the group of at least three processing steps the buyer performs to approve and s pay the invoice; and
the step of rendering a pop-up object over the report document includes, if the exception condition is text populated by the buyer to the text field, rendering of the text populated by the buyer to the text field.

5. The system of claim 1, wherein:
at least one step of the group of three processing steps further comprises at least a fourth step, the fourth step being a step which:
the buyer performs to approve and pay the invoice if the invoices is a first type of invoice;
the buyer does not perform if the invoice is a second type of invoice distinct from the first type of invoice; and
the steps of the invoice application further:
identify whether the invoice is the first type of invoice or the second type of invoice;
if the invoice is the first type, the multi-segment status control comprises a fourth segment representing the fourth step, the fourth segment being the first color if the fourth processing step has not yet been performed for the invoice identified in the row and the second color if the fourth processing step; and
if the invoice is the second type, the multi-segment status control excludes the fourth segment.

6. The system of claim 1, wherein:
each invoice object further comprises a dispute flag identifying whether the buyer has placed the invoice into a dispute status;
the step of generating the report further comprises populating all segments of the multi-segment status control with a third color, distinct from the first color and the second color, if the dispute status exists.

7. The system of claim 6, wherein:
the database further comprises, in association with the dispute flag, a text field which, if populated with text by the buyer, identifies the buyer's basis for the dispute;
the document template further comprises an embedded pop-up object; and
the instructions of the invoice application further comprise:
the step of populating all segments of the multi-segment status control with the third color further comprises populating all segments with an active link; and
upon user selection of the active link, rendering a pop-up object over the report document, the pop-up object identifying the buyer's basis for the dispute.

8. A method of reporting approval and payment status of a group of invoices issued by a vendor, the method comprising:
in response to a report request comprising access credentials of a connecting vendor:
obtaining from a database, for each invoice having at least an invoice having an identification of an issuing vendor matching the connecting vendor, an invoice ID number and, with respect to at least three processing steps a buyer performs to approve and pay the invoice, identification of whether the buyer has performed the processing step;
rendering a report document on a display screen, the report document comprising a group of horizontal rows, each row representing a unique one of the group of invoice objects obtained from the database, each row comprising:
the invoice identifier;
a first multi-segment status control comprising a group of segments arranged linearly within the horizontal row, each segment representing a unique step within the group of at least three processing steps the buyer performs to approve and pay the invoice;
each segment being a first color if the segment represents a processing step that the buyer has not yet performed for the invoice identified in the row and a second color distinct from the first color if the segment represents a processing step that the buyer has completed for the invoice identified in the row.

9. The method of claim 8, further comprising:
with respect to each processing step that the buyer has not yet performed for the invoice identified in the row, looking up exception criteria and determining whether an exception condition exists for that processing step; and
if an exception condition exists for a processing step, rendering the segment which corresponds to the processing step a third color distinct from the first color and the second color.

10. The method of claim 9, further comprising:
if an exception condition exists for a processing step, rendering the segment which corresponds to the processing step as an active link; and
upon user selection of the active link, rendering a pop-up object over the report document, the pop-up object identifying the exception condition.

11. The method of claim 10, wherein:
the step of rendering a pop-up object over the report document includes, if the exception condition is text populated by the buyer to a text field, rendering of the text populated by the buyer to the text field.

12. The method of claim 8, wherein:
at least one step of the group of three processing steps further comprises at least fourth step, the fourth step being a step which:
the buyer performs to approve and pay the invoice if the invoices is a first type of invoice;
the buyer does not perform if the invoice is a second type of invoice distinct from the first type of invoice; and
the method further comprises:
identifying whether the invoice is the first type of invoice or the second type of invoice;
if the invoice is the first type, the multi-segment status control comprises a fourth segment representing the fourth step, the fourth segment being the first color if the fourth processing step has not yet been performed for the invoice identified in the row and the second color if the fourth processing step; and
if the invoice is the second type, the multi-segment status control excludes the fourth segment.

13. The method of claim 8, further comprising:
determining whether the buyer has placed the invoice into a dispute status; and
the step of generating the report further comprises populating all segments of the multi-segment status control with a third color, distinct from the first color and the second color, if the dispute status exists.

14. The method of claim 13, wherein:
if dispute status exists, rendering all segments of the multi-segment status control as an active link; and
upon user selection of the active link, rendering a pop-up object over the report document, the pop-up object identifying the buyer's basis for the dispute.
